(19) United States
(12) Patent Application Publication
(10) Pub. No.: US 2010/0097663 A1
(43) Pub. Date: Apr. 22, 2010

(54) Scanning device with versatile media feed configuration

(76) Inventor: Hin Leong Tan, Sunnyvale, CA (US)

Correspondence Address: DOUGLAS L WELLER, 431 MAGNOLIA LANE, SANTA CLARA, CA, 95051, US

(21) Appl. No.: 12/288,211

(22) Filed: Oct. 17, 2008

(51) Int. Cl. H04N 1/04

(52) U.S. Cl. 358/474

(57) ABSTRACT

An optical scanning device is useful for scanning business cards. The optical scanning device includes an image scanner, a roller and a support base. The image scanner scans a surface of a card. The roller moves the card across a surface of the image scanner. The support base is arranged to support the image scanner on a horizontal surface so that an axis of rotation of the roller is not parallel to the horizontal surface. This results in the image scanner scanning cards in a non-horizontal orientation.

### BACKGROUND

Typically scanning devices are arranged in a flatbed configuration, in which media is placed on a plate of glass and a movable scanner provides a scan of surface media through the glass, or are arranged in a sheet feed configuration in which media, either face down or face up, is respectively passed under or over an image scanner.

While currently available scanner configuration meet the majority of needs, for specialty needs such as scanning business cards, more versatility in media feed configurations can allow for increased ergonomics and efficiency of use.

### BRIEF DESCRIPTION OF THE DRAWINGS

FIG. 1 is a card scanner configured with a sheet feed mechanism into which media, in a vertical orientation, can be received and scanned in accordance with an embodiment of the present invention.

FIG. 2 and FIG. 3 show a side view of media being fed into the card scanner shown in FIG. 1, in accordance with an embodiment of the present invention.

FIG. 4 and FIG. 5 show alternative configurations for a card scanner into which media, depending upon the card scanner configuration, can be fed in a vertical or horizontal orientation in accordance with an embodiment of the present invention.

FIG. 6 and FIG. 7 shows the card scanner shown in FIG. 4 and FIG. 5, configured to allow media in a slanted orientation to be fed into the card scanning for scanning in accordance with an embodiment of the present invention.

FIG. 8, FIG. 9, FIG. 10, FIG. 11 and FIG. 12, show universal serial bus ports being available on multiple sides of the card scanner shown in FIG. 6 and FIG. 7 in order to allow for flexibility in orienting the position of the optical scanner in accordance with embodiments of the present invention.

### DESCRIPTION OF THE EMBODIMENT

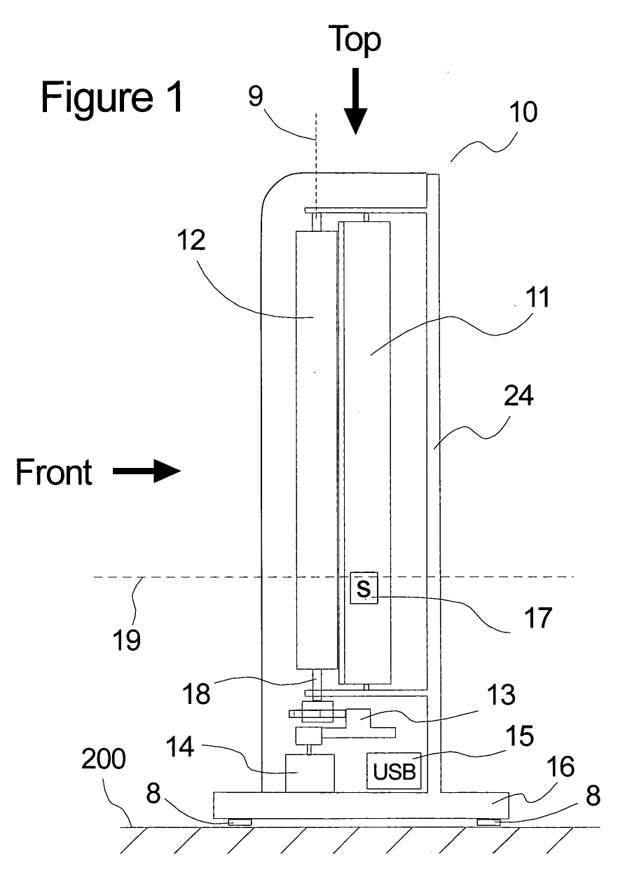

FIG. 1 shows a card scanner 10. A support base 16 integrated into housing 24 of card scanner 10 holds card scanner 10 in a vertical orientation allowing media, such as a business card, in a vertical orientation to be received and scanned. What is meant by a vertical orientation is an orientation in which surfaces of the media are perpendicular to a horizontal surface 200 on which base 16 resides. By contrast, a horizontal orientation of the media is an orientation in which surfaces of the media are parallel to horizontal surface 200.

For example, card scanner 10 is an optical scanner that includes a roller 12 that moves media against a contact imaging sensor (CIS) 11. A motor 14 and gears 13 cause roller 12 to rotate around an axel 18. A media sensor 17 is used to sense when media is entering the housing 24 of card scanner 10, triggering rotation of roller 12 around axel 18. A universal serial bus (USB) module 15 is used to allow connection of card scanner 10 to a host device, such as a personal computer. Feet 8, connected to support base 16 support card scanner 10 in a vertical orientation with respect to horizontal surface 200.

Roller 12 rotates on an axis of rotation 9 that is perpendicular to horizontal surface 200. As evidenced by the presence of feet 8, base 16 is designed so that an axis of rotation 9 of roller 12 is perpendicular to horizontal surface 200. The result is that business cards are both fed in and scanned in a configuration perpendicular to horizontal surface 200. This arrangement so that axis of rotation 9 of roller 12 is perpendicular to surface 200 has the advantage of reducing the footprint of card scanner 10. This is advantageous, for example, if horizontal surface 200 is the surface of a cluttered desk. Also, users may find feeding cards into card scanner 10 is ergonomically superior to the tradition method of feeding and scanning business cards into an optical scanner where the axis of rotation of the roller is parallel to the horizontal surface on which the optical scanner is placed.

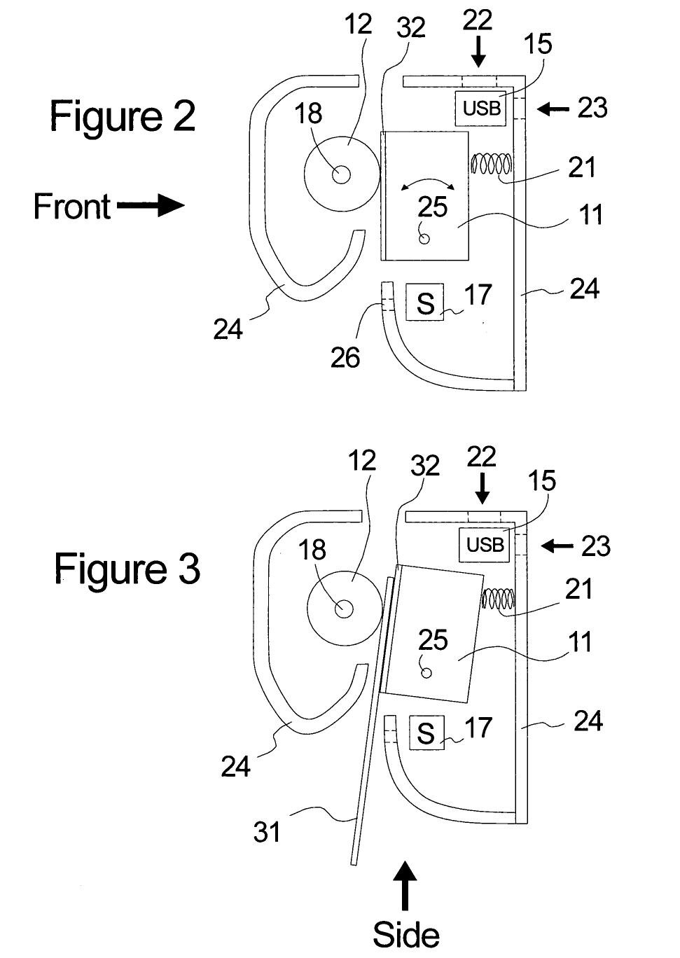

A dotted line 19 shows the location of a cut away view of card scanner 10 shown in FIG. 2 and FIG. 3. FIG. 2, shows CIS 11 able to pivot around an axel 25. A spring 21 applies force to CIS 11, keeping a glass surface 32 of CIS 11 in contact with roller 12 when no media is being scanned. USB module 15 allows connectivity to a USB cable either through an opening 22 in housing 24, or through an opening 23 through housing 24. The use of a dual ported USB module allows flexibility in the location at which a USB cable can be connected to card scanner 10.

FIG. 3, illustrates how sensor 17 optically detects, through an opening 26 in housing 24, when media 31 enters card scanner 10. When media is detected, CIS 11 is activated. Also, motor 14 (shown in FIG. 1) begins operating and through gears 13 turns roller 12. Roller 12 moves media 31 across glass surface 32 of CIS 11, allowing a scan of the contents on the surface of media facing CIS 11 to be captured by card scanner 10.

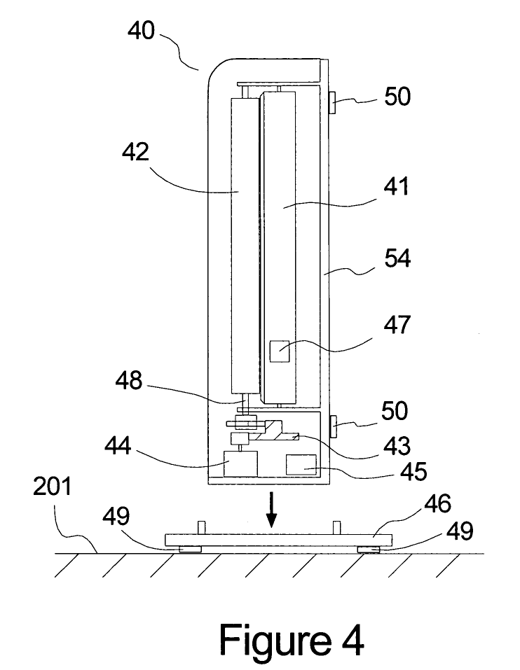

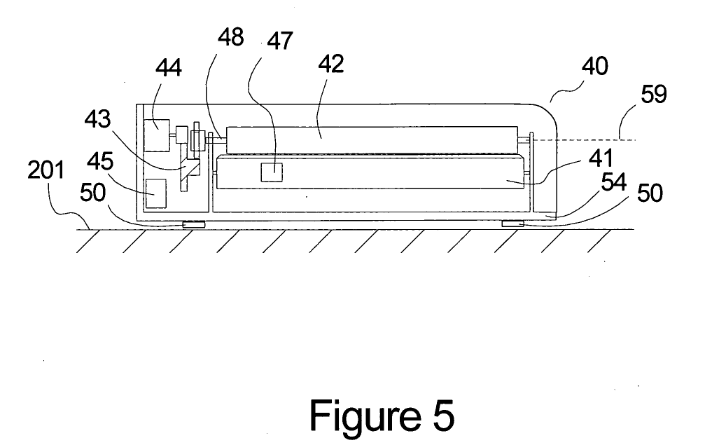

FIG. 4 and FIG. 5 show a card scanner 40 with an optionally used support base 46, with feet 49. Feet 49 are designed to support card scanner 40 in a vertical orientation with respect to a horizontal surface 201, allowing media in a vertical orientation to be received and scanned. Alternatively, card scanner 40 can be supported by feet 50 in a horizontal orientation with respect to surface 201, allowing media to be fed into and scanned by card scanner 40 in a horizontal orientation. When card scanner 40 is in a horizontal orientation, an axis of rotation 59 of roller 12 is parallel to horizontal surface 201.

Card scanner 40 is, for example, an optical scanner that includes a roller 42, that moves media against a contact imaging sensor (CIS) 41. A motor 44 and gears 43 cause roller 42 to rotate around an axel 48. A media sensor 47 is used to sense when media is entering the housing 54 of card scanner 40, triggering rotation of roller 42 around axel 48. A universal serial bus (USB) module 45 is used to allow connection of card scanner 40 to a host device, such as a personal computer.

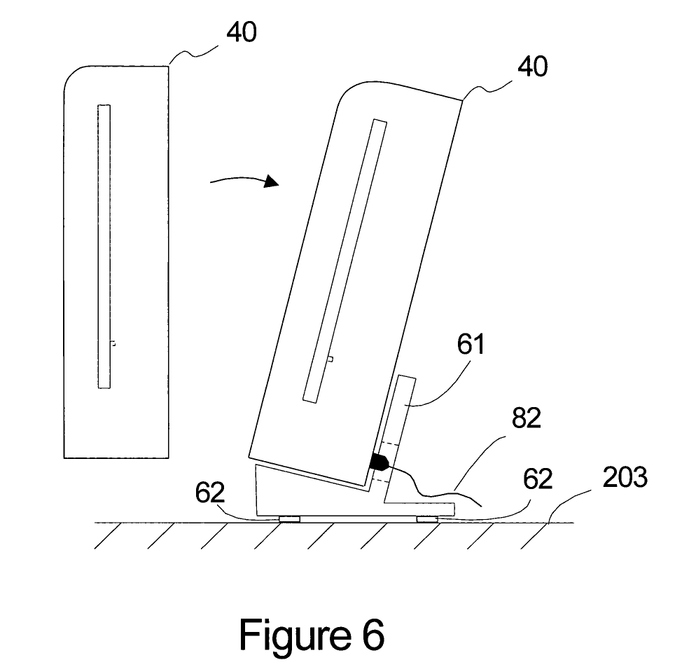

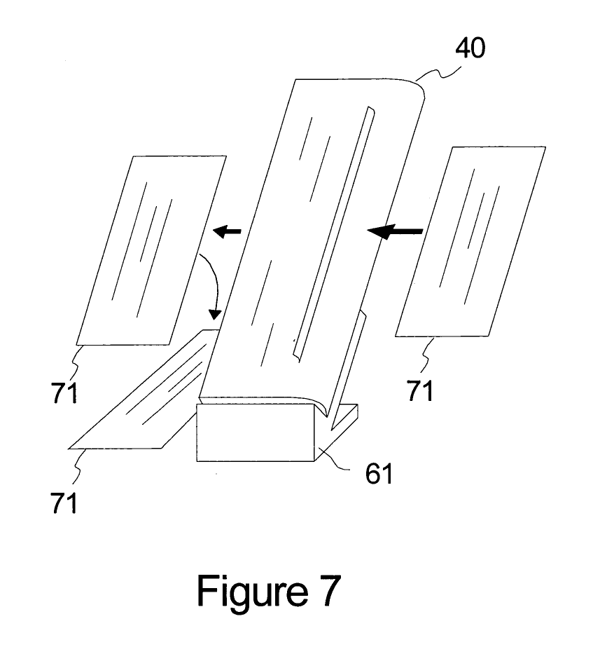

FIG. 6 and FIG. 7 show card scanner 40 with a stand 61. Stand 61 includes feet 62 design to support stand 61 on a horizontal surface 203. Support base 61 holds card scanner 40 in a slanted orientation allowing media 71 (shown in FIG. 7) to be fed into card scan 40 in a slanted orientation. What is meant by a slanted orientation is an orientation that is neither vertical nor horizontal, but is between vertical and horizontal. FIG. 7 shows how, when card scanner 40 is situated upon support base 61, media 71, after being scanned by card scanner 40, can be automatically stacked next to support base 61.

When card scanner 40 is mounted on support base 61, axis of rotation 59 of roller 42 is neither perpendicular nor horizontal to horizontal surface 203, but is instead in a slanted orientation to horizontal surface 203. The result is that business cards are both fed in and scanned in a configuration slanted with respect to horizontal surface 203. This slanted mounting of the axis of rotation of 59 of roller 42 so that axis of rotation 59 of roller 42 is slanted with respect to horizontal surface 203 has the advantage of reducing the footprint of card scanner 40. Also, users may find feeding cards into card scanner 40 in a slanted orientation is ergonomically superior to the tradition method of feeding and scanning business cards into an optical scanner where the axis of rotation of rotation of the roller is parallel to the horizontal surface on which the optical scanner is placed. The automatic stacking of scanned cards is another advantage of the slanted orientation of card scanner 40 when mounted on support base 61.

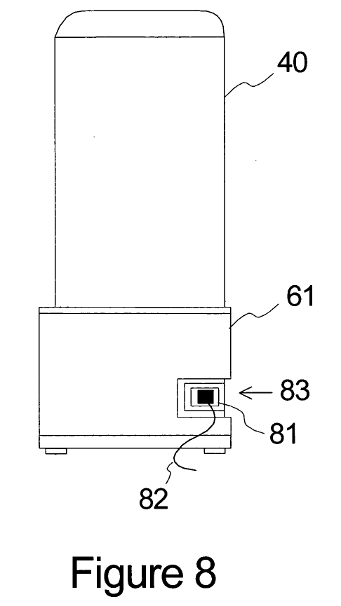

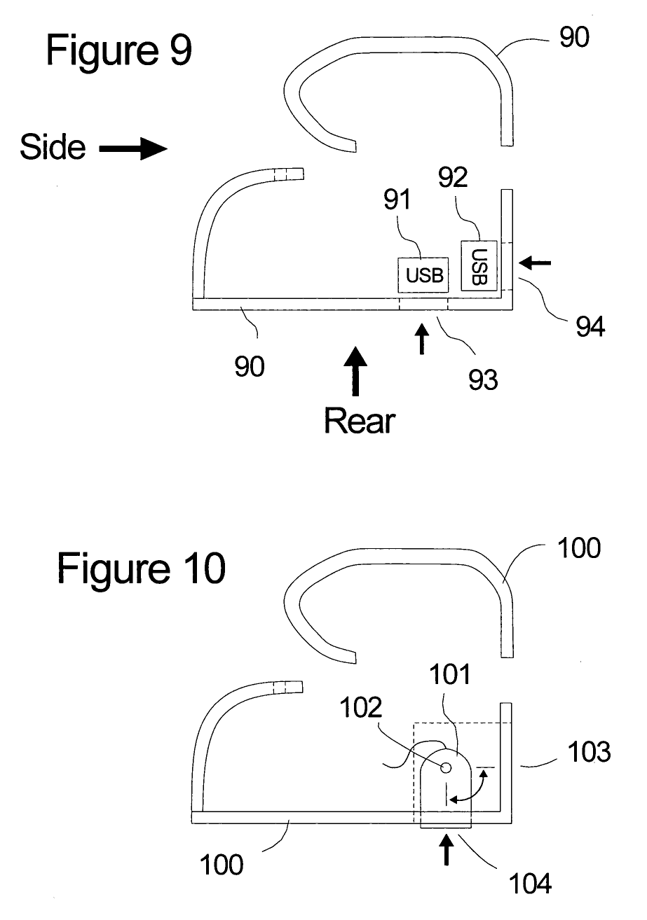

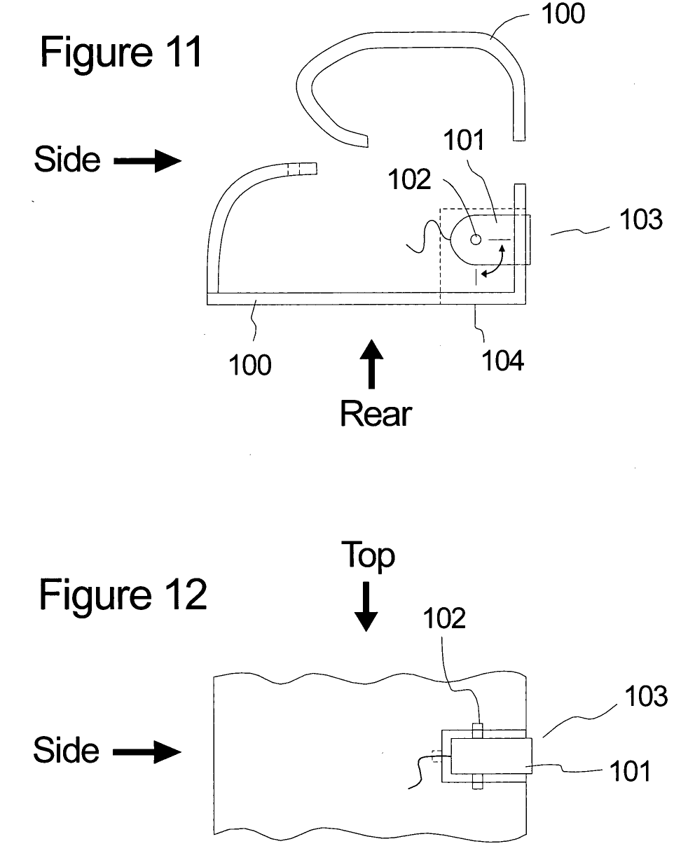

FIG. 8 shows how a notch 83 in support base 61 allows a USB cable 82 to be connected to a USB port 81 of card scanner 40.

FIG. 9 is a cut-away view of a card scanner showing how a USB module includes a USB port 91 that can be accessed through an opening 93 in one side of housing 90, and a USB port 92 that can be accessed through an opening 94 in another side of housing 90.

FIG. 10, FIG. 11 and FIG. 12 are cut-away views of a card scanner showing how a USB module 101 can be rotated around an axel 101 to alternatively allowing USB connection through an opening 103 on one side of housing 100, or an opening 104 on another side of housing 100.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

I claim:

1. An optical scanning device useful for scanning cards comprising:
an image scanner that scans a surface of a card;
a roller that moves the card across a surface of the image scanner; and, a support base arranged to support the image scanner on a horizontal surface so that an axis of rotation of the roller is not parallel to the horizontal surface resulting in the image scanner scanning cards in a non-horizontal orientation.

2. An optical scanning device as in claim 1 wherein the support base supports the image scanner so that the axis of rotation is perpendicular to the horizontal surface resulting in the image scanner scanning cards in a vertical orientation.

3. An optical scanning device as in claim 1 wherein the support base supports the image scanner so that the axis of rotation is neither perpendicular nor parallel to the horizontal surface resulting in the image scanner scanning cards in a slanted orientation.

4. An optical scanning device as in claim 1 additionally comprising:
a sensor that indicates when a card is entering the card scanning device.

5. An optical scanning device as in claim 1 additionally comprising:
a universal serial bus (USB) module that allows a USB connection to the card scanning device at multiple locations on housing of the card scanning device.

6. An optical scanning device as in claim 1 additionally comprising:
a universal serial bus (USB) module that includes multiple USB ports that allows a USB connection to the card scanning device at multiple locations on housing of the card scanning device.

7. An optical scanning device as in claim 1 additionally comprising:
a universal serial bus (USB) module that includes a USB port that can be moved so as to allow a USB connection to the card scanning device at one of multiple locations on housing of the card scanning device.

8. An optical scanning device as in claim 1 wherein the support base supports the image scanner so that the axis of rotation is neither perpendicular nor parallel to the horizontal surface resulting in the image scanner scanning cards in a slanted orientation, an angle of the axis of rotation to the horizontal surface being selected so that cards after passing through the image scanner fall into a stacked arrangement of cards.

9. An optical scanner comprising:
a media feeder that receives media and moves the media through the optical scanner, the media feeder including a roller;
an image scanner, connected to the media feeder, the image scanner scanning the media to obtain an image; and,
a support base that supports the media feeder and the image scanner on a horizontal surface so that an axis of rotation of the roller is not parallel to the horizontal surface resulting in the image scanner scanning media in a non-horizontal orientation

10. An optical scanner as in claim 9 wherein the support base supports the media feeder and the image scanner so that the axis of rotation is perpendicular to the horizontal surface resulting in the image scanner scanning media in a vertical orientation.

11. An optical scanner as in claim 9 wherein the support base supports the image scanner so that the axis of rotation is neither perpendicular nor parallel to the horizontal surface resulting in the image scanner scanning media in a slanted orientation.

12. An optical scanning device as in claim 9 wherein the support base supports the image scanner so that the axis of rotation is neither perpendicular nor parallel to the horizontal surface resulting in the image scanner scanning media in a slanted orientation, an angle of the axis of rotation to the horizontal surface being selected so that media after passing through the image scanner fall into a stacked arrangement.

13. An optical scanner as in claim 9 additionally comprising:
a universal serial bus (USB) module that allows a USB connection to the optical scanner at multiple locations on housing of the optical scanner.

14. An optical scanner as in claim 9 additionally comprising:
a universal serial bus (USB) module that includes multiple USB ports that allows a USB connection to the optical scanner at multiple locations on housing of the optical scanner.

15. An optical scanner as in claim 9 additionally comprising:
a universal serial bus (USB) module that includes a USB port that can be moved so as to allow a USB connection to the optical scanner at one of multiple locations on housing of the optical scanner.

16. A card scanner comprising:
means for scanning a card to obtain from the card a scanned image;
means for receiving the card and moving the card across a surface of the means for scanning, including a roller that moves the card across a surface of the means for scanning; and,
means for supporting the card scanner on a horizontal surface so that an axis of rotation of the roller is not parallel to the horizontal surface resulting in the card scanner scanning cards in a non-horizontal orientation.

17. A card scanner as in claim 16 wherein the means for supporting the card scanner supports the means for receiving the card and the means for scanning so that so that the axis of rotation is perpendicular to the horizontal surface resulting in the card scanner scanning cards in a vertical orientation.

18. A card scanner as in claim 16 wherein the means for supporting the card scanner supports the means for scanning so that the axis of rotation is neither perpendicular nor parallel to the horizontal surface resulting in the card scanner scanning cards in a slanted orientation.

19. A card scanner as in claim 16 wherein the means for supporting the card scanner supports the means for scanning so that the axis of rotation is neither perpendicular nor parallel to the horizontal surface resulting in the card scanner scanning cards in a slanted orientation, an angle of the axis of rotation to the horizontal surface being selected so that cards after passing through the card scanner fall into a stacked arrangement of cards.

20. A card scanner as in claim 16 additionally comprising:
means for allowing a USB connection to the card scanner at multiple locations on housing of the card scanner.
